(19) United States
(12) Patent Application Publication
(10) Pub. No.: US 2026/0015831 A1
(43) Pub. Date: Jan. 15, 2026

(54) SYSTEM AND METHOD OF OPERATING PERCEPTION DEVICES IN MOBILE MACHINES

(71) Applicant: Caterpillar Inc., Peoria, IL (US)

(72) Inventor: Alex Michael Fullenkamp, Fort Madison, IA (US)

(73) Assignee: Caterpillar Inc., Peoria, IL (US)

(21) Appl. No.: 18/769,486

(22) Filed: Jul. 11, 2024

(51) Int. Cl. E02F 9/26; G01S 13/60

(52) U.S. Cl. CPC E02F 9/262; G01S 13/60

(57) ABSTRACT

A system for operating a radar device of a mobile machine is disclosed. The system includes an actuator operably coupled between the radar device and an exterior of the mobile machine. The system further includes a controller configured to receive an input indicative of a ground speed of the mobile machine. The controller is further configured to control the actuator to tilt the radar device with respect to a ground plane to alter a field of view of the radar device based on the input received by the controller.

### TECHNICAL FIELD

The present disclosure relates to perception devices, e.g., radar devices, mounted on mobile machines. More particularly, the present disclosure relates to a system and a method of altering a field of view of a perception device mounted on a mobile machine.

### BACKGROUND

Mobile machines, such as dozers, excavators, pavers, and other types of equipment, operate across a wide range of ground speeds to perform various tasks, such as material gathering, material distribution, material removal, or other geography-altering tasks. These machines may be equipped with perception devices, such as radar devices, to detect and/or monitor surroundings of the machines.

These perception devices generally have a fixed vertical field of view with a narrow vertical viewing angle, for example, ranging between plus-minus five degrees. As these perception devices are mounted in a fixed orientation (on the machine), their ability to effectively detect and monitor surroundings of the machine is optimized for certain ground speeds of the machine but may be compromised at other ground speeds of the machine, thereby hindering the overall performance of the perception devices and the mobile machine.

United States Patent Publication No. 2023/0049866 discloses a radar installation and calibration systems and methods. In one example, a controller of a radar system receives installation parameters associated with an installation of a radar system. A present orientation of a radar device of the radar system is determined and compared to the installation parameters to determine a deviation of the present orientation from the installation parameters. The deviation is sent to a coordinating device associated with the radar device to cause the deviation to be outputted as installation feedback through the coordinating device.

### SUMMARY OF THE INVENTION

In an embodiment, the present disclosure relates to a system for operating a radar device of a mobile machine. The system includes an actuator operably coupled between the radar device and an exterior of the mobile machine. The system further includes a controller configured to receive an input indicative of a ground speed of the mobile machine. The controller is further configured to control, based on the input, the actuator to tilt the radar device with respect to a ground plane to alter a field of view of the radar device.

In another embodiment, the present disclosure relates to a mobile machine including an exterior and a perception device having a field of view. The mobile machine further includes a system for operating a perception device of a mobile machine. The system includes an actuator operably coupled between the radar device and an exterior of the mobile machine. The system further includes a controller configured to receive an input indicative of a ground speed of the mobile machine. The controller is further configured to control, based on the input, the actuator to tilt the radar device with respect to a ground plane to alter a field of view of the radar device.

In yet another embodiment, the present disclosure relates to a method of operating a perception device of a mobile machine. The method includes receiving, by a controller, an input indicative of a ground speed of the mobile machine. The method further includes controlling, by the controller, an actuator operably coupled between the perception device and an exterior of the mobile machine, based on the input, to tilt the perception device with respect to a ground plane to alter a field of view of the perception device.

### BRIEF DESCRIPTION OF THE DRAWINGS

FIG. 1 is a side view of an exemplary mobile machine including a perception device, according to some embodiments of the present disclosure;

FIG. 2 is a diagrammatic view illustrating a system for operating a perception device of the perception system, according to some embodiments of the present disclosure;

FIG. 3 is a perspective view of the perception system, according to some embodiments of the present disclosure;

FIG. 4 is an exploded view of the perception system, according to some embodiments of the present disclosure;

FIG. 5 is a partial side view of the perception system illustrating the system of FIG. 2 in a first configuration when a ground speed of the mobile machine is less than a speed threshold, according to some embodiments of the present disclosure;

FIG. 6 is a partial side view of the perception system illustrating the system of FIG. 2 in a second configuration when the ground speed of the mobile machine is greater than a speed threshold, according to some embodiments of the present disclosure;

FIG. 7 is a graph showing a relation between the ground speed and an angle defined by the perception system with respect to exterior of the mobile machine, according to some embodiments of the present disclosure; and

FIG. 8 is a flow chart depicting an exemplary method for operating the perception device of the mobile machine, according to some embodiments of the present disclosure.

### DETAILED DESCRIPTION

Reference will now be made in detail to specific embodiments or features, examples of which are illustrated in the accompanying drawings. Wherever possible, the same reference numbers will be used throughout the drawings to refer to the same or the like parts.

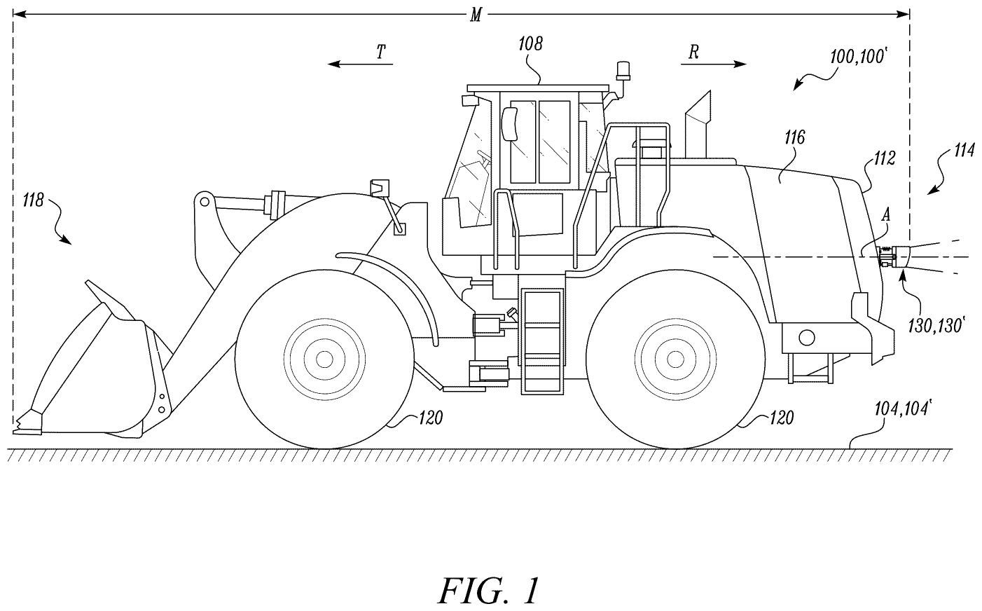

Referring to FIG. 1, an exemplary mobile machine 100 is described. The mobile machine 100 may be a wheel loader 100′ operable at a worksite 104′ having a ground plane 104. The worksite 104′ may include a mine site, a landfill, a quarry, a construction site, or any other type of worksite known in the art. Although the mobile machine 100 is depicted as a wheel loader, it is contemplated that mobile machine 100 may embody any other type of mobile work machine, for example, an off-highway haul truck, an excavator, a scraper, a cold planer, paver, or a motor grader. The mobile machine 100 may include a cab or an operator station 108, a power source 116, and a plurality of traction members 120 configured to move the mobile machine 100 in a first direction (see direction R, in FIG. 1). Further, the mobile machine 100 may define an exterior 112, which may be defined by one or more of an outer body panel, a portion of a frame, a section of a hood, and/or the like parts of the mobile machine 100. Further, the mobile machine 100 may define a rear portion 114 and a front portion 118 and a horizontal axis, A. The horizontal axis, A, may extend along the length, M, of the mobile machine 100 and may be parallel to the ground plane 104.

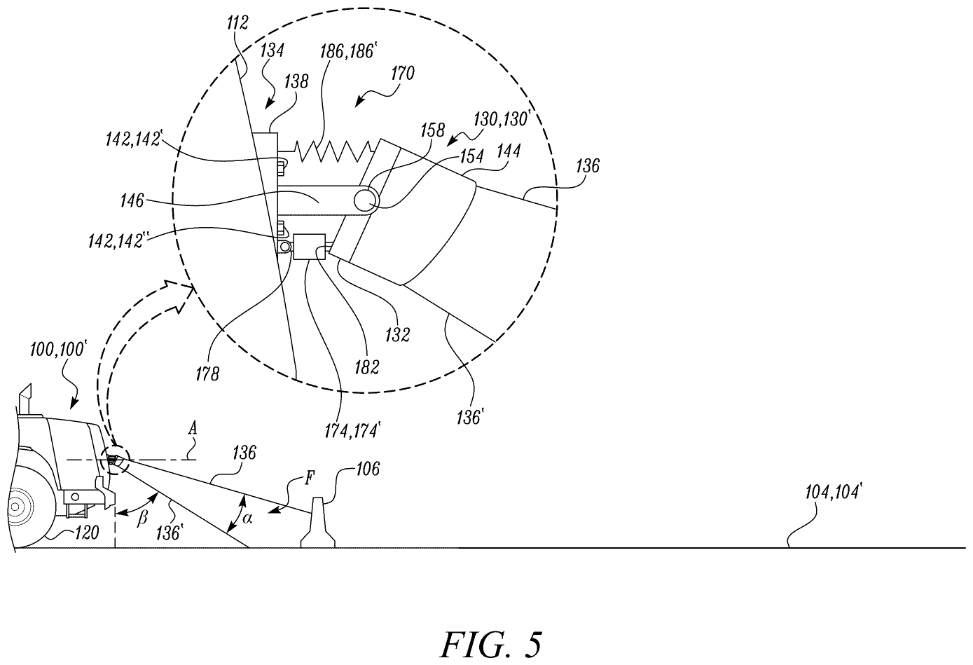

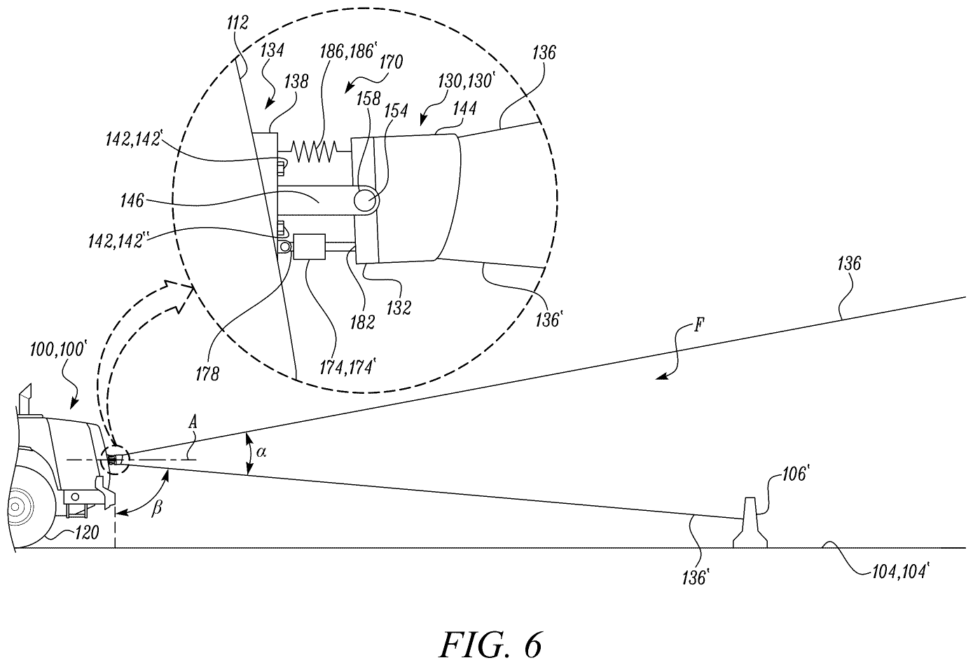

As is generally found in various worksites, the worksite 104′ may include various objects (e.g., see object 106, 106′ in FIGS. 5 and 6). As shown, the object 106 may be relatively raised or elevated with respect to the ground plane 104 and can include one or more of a personnel, machines, obstacles, boulders, and multiple other such similar structures (some of which can potentially lie in any exemplary travel path of the mobile machine 100 at any given point) and against which it may be undesirable for the mobile machine 100 to interfere or collide with. To avoid such interference or collision, the mobile machine 100 may include a perception system 124.

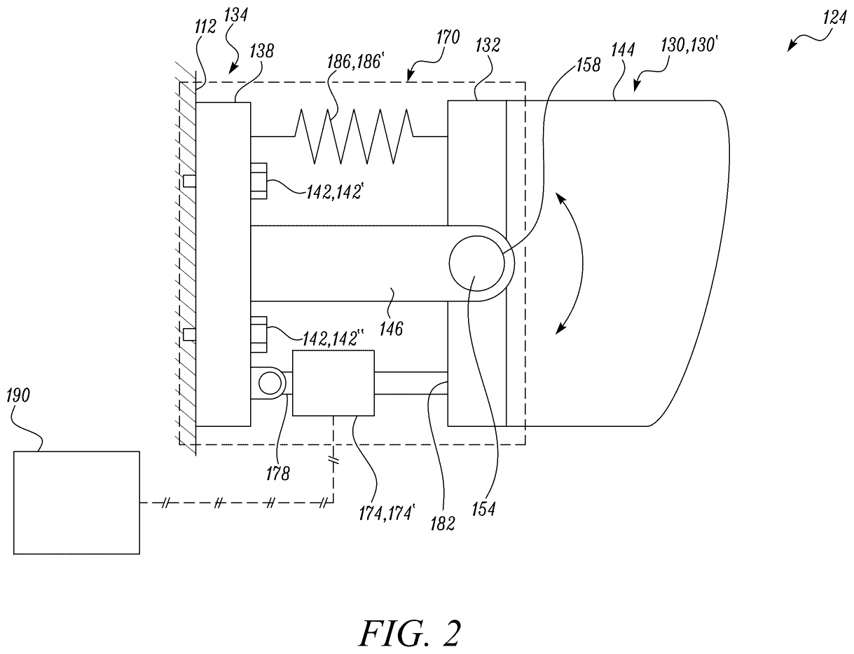

Referring now to FIGS. 1 and 2, the perception system 124 may be mounted to the exterior 112 of the mobile machine 100. The perception system 124 may include a perception device 130. The perception device 130 may include a radar device 130′. Although the perception device 130 is depicted as a radar device 130′, it is contemplated that perception device 130 may include or embody any other type of perception device, for example, a SONAR (Sound Navigation and Ranging) device, a LIDAR (Light Detection and Ranging) device, a camera vision device, 3-dimensional sensors, and the like devices. The perception device 130 may define a body 132. The perception device 130 also defines a field of view in which the object 106 may be detected by the perception device 130. The perception device 130 may define a field of view diverging further rearwards and outwards of the mobile machine 100, e.g., in a conical form. The field of view may include a segment defining a vertical field of view, F, having a first field extent 136 a second field extent 136′ (see FIG. 5) and also diverging further rearwards and outwards of the mobile machine 100, but along a vertical plane extending along (e.g., passing through) the length, M, of the mobile machine 100. The vertical field of view, F, may define a vertical viewing angle α in a vertical plane extending along the length, M, of the mobile machine 100. Further, the vertical field of view, F, may define an angle β defined by the perception device 130 with respect to the exterior 112 of the mobile machine 100. For example, the angle β may be formed between the second field extent 136′ and the exterior 112 of the mobile machine 100.

The perception system 124 may include a mounting assembly 134 configured to retain the perception device 130 on the mobile machine 100. The perception device 130 may be mounted on the exterior 112 of the mobile machine 100 by using the mounting assembly 134. In the illustrated embodiment, the perception device 130 is mounted on the rear portion 114 of the mobile machine 100, however, it is contemplated that the perception device 130 may be mounted on the front portion 118 of the mobile machine 100. Further, the mounting assembly 134 may include a mount 138 configured to retain the perception device 130 with the exterior 112 of the mobile machine 100. The mount 138 may be connected to the exterior 112 by using fasteners 142 (e.g., a first fastener 142′ and a second fastener 142″) of the mounting assembly 134. The mount 138 may have a cuboidal shape, however, the mount 138 may have any shape or size depending upon the exterior 112 of the mobile machine 100, and by way of which the mount 138 may be neatly (e.g., well aesthetically) integrated into the exterior 112. In some embodiments, the mount 138 may be permanently fixed to the exterior 112, for example by welding. The mount 138 may be made of any suitable material, including but not limited to, one or more of metal, polymer, plastic, and the like materials.

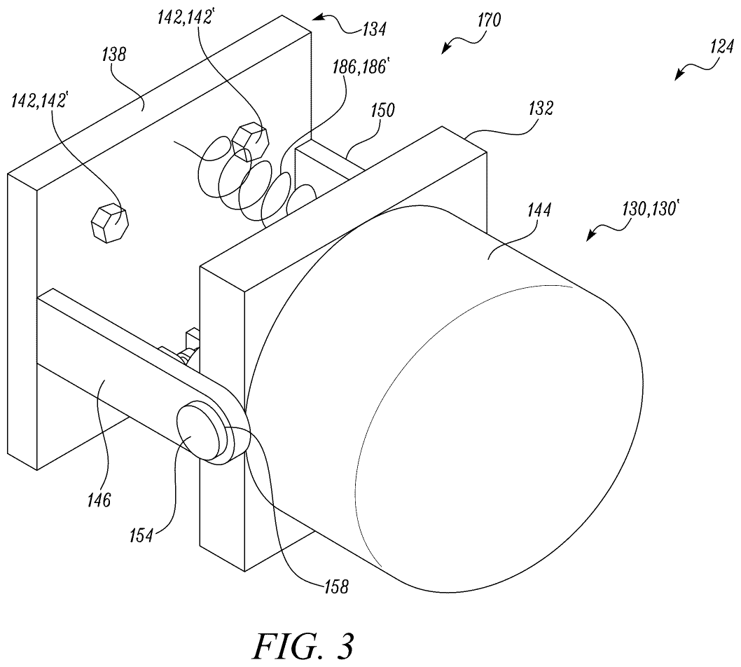

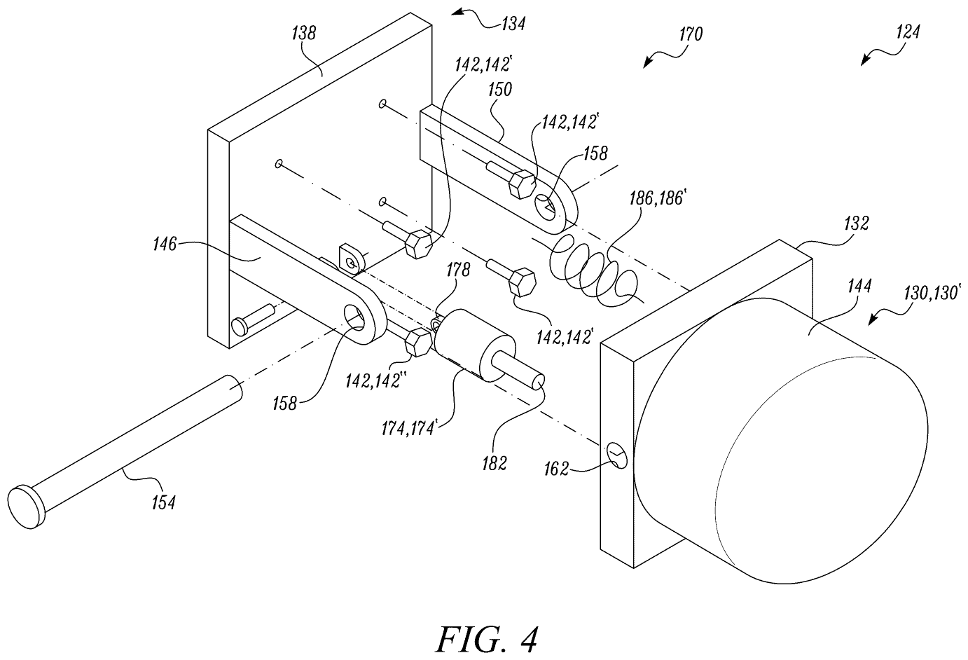

Referring to FIGS. 3 and 4, the mounting assembly 134 may further include at least two brackets (e.g., a first bracket 146 and a second bracket 150). The first bracket 146 and the second bracket 150 may extend (e.g., parallelly as shown) from the mount 138 and may be pivotably connected to the body 132 of the perception device 130. The perception device 130 may be placed in between the first bracket 146 and the second bracket 150. As an example, the body 132 of perception device 130 may be connected between the first bracket 146 and the second bracket 150 by utilizing a pin 154. In this regard, the pin 154 may pass through a hole 158 extending through the body 132 and may also pass through slots (e.g., see slot 162) formed on the first bracket 146 and the second bracket 150. In doing so, the body 132 or the perception device 130 may be pivotally connected with the first bracket 146 and the second bracket 150 and may thus articulate with respect to the mount 138 and to the exterior 112 of the mobile machine 100.

Referring to FIGS. 2 and 4, the mobile machine 100 and/or the perception system 124 may further include a system 170 for operating the perception device 130. The system 170 may include an actuator 174 operably coupled between the perception device 130 and the exterior 112 (or the mount 138 connected to the exterior 112). Particularly, the actuator 174 is operably coupled between the body 132 of perception device 130 and the mount 138 of the mounting assembly 134—e.g., the body 132 may be a part of and/or may be integrally formed with an outer panel 144 of the perception device 130. For example, the actuator 174 may define a first end 182 which may be connected (e.g., pivotably) to the body 132. Further, the actuator 174 may define a second end 178, which may be connected (e.g., pivotably) to the mount 138. The actuator 174 may be applied to tilt the perception device 130 with respect to the mount 138 and thus to the ground plane 104. For example, the actuator 174 may tilt the perception device 130 to a first configuration of the system 170 when a ground speed of the mobile machine 100 is less than a speed threshold. Similarly, the actuator 174 may tilt the perception device 130 to a second configuration of the system 170 when the ground speed of the mobile machine 100 is higher than a speed threshold. The actuator 174 may include a linear electronic actuator 174′, although the actuator 174 may include other type of actuators, for example, hydraulic actuators, pneumatic actuators, piezoelectric actuators, and the like. In some embodiments, the actuator 174 may be replaced by a motor and a gear mechanism. For example, the motor may be electrically coupled to the controller 190. The controller 190 may control the motor to tilt the perception device 130 by using one or more gears coupled between the motor and the perception device 130.

The system 170 further includes a biasing member 186. The biasing member 186 may extend from the mount 138 of the perception device 130 to the exterior 112 of the mobile machine 100. The biasing member 186 is a spring 186′, however, it is contemplated that the biasing member 186 may embody any other type of biasing devices, for example, coiled springs, pneumatic cylinder/piston arrangements, and the like. The biasing member 186 may be configured to bias the perception device 130 towards a default tilt position (in the first configuration), e.g., a position that is corresponding to a stationary state of the mobile machine 100 relative to the ground plane 104. The biasing member 186 may be further configured to arrest any play or slack during the movement of the mobile machine 100, thereby keeping the perception device 130 steady when the mobile machine 100 is moving with respect to the ground plane 104 at high speeds. The high speed of the mobile machine 100 may be defined as a speed greater than a predefined speed threshold.

The system 170 further includes a controller 190. The controller 190 is electrically and communicably coupled to the actuator 174. The controller 190 may include a computing device having a single microprocessor or multiple microprocessors. For example, the controller 190 may include a memory, a secondary storage device, a clock, and a processing hardware, one or more of which may be used, in concert with another part of the controller 190, for accomplishing a task as discussed below in the present disclosure. The controller 190 may be configured to receive inputs (e.g., data related to the ground speed of the mobile machine 100) from one or more components (e.g., a machine or an engine control module (ECM) (not shown) of the mobile machine 100, process the input, and generate output signals based on the date inputs and/or the processed data.

In some embodiments, the inputs related to the ground speed of the mobile machine 100 may be obtained by one or more speed sensors of the mobile machine 100. In some embodiments, the speed sensos may include accelerometers, IMU (Inertial Measurement Unit) sensors, and the like. The controller 190 is further configured to generate an output signal to control the actuator 174 to tilt the perception device 130 with respect to a ground plane 104. As a result, the vertical field of view, F, of the perception device 130 is altered based on the ground speed of the mobile machine 100. For example, the controller 190 may retrieve a chart (from the memory) which may include multiple predefined angles defined by the perception system 124 with respect to the exterior 112 of the mobile machine 100 (see angle β) corresponding to multiple predefined speeds of the mobile machine 100. The controller 190 may be configured to compare the ground speed with a predefined speed which may in turn correspond to an angle β in the chart. The controller 190 may control the actuator 174 to alter the angle of the perception device 130 to said angle β based on the ground speed of the mobile machine 100. As a result, the vertical field of view, F, may also be altered. In some embodiments, the angle β may be directly proportional to the ground speed of the mobile machine 100.

Referring to FIGS. 5 and 6, the controller 190 may be configured to control the actuator 174 to tilt the perception device 130 upwards with respect to the ground plane 104 (e.g., in the first configuration) when the ground speed of the mobile machine 100 is increased from the ground speed at which the mobile machine 100 is currently moving. The tilting of the perception device 130 upward with respect to the ground plane 104 prevents the vertical field of view, F, of the perception device 130 from intersecting the ground plane 104. Similarly, the controller 190 may be configured to control the actuator 174 to tilt the perception device 130 downwards with respect to the ground plane 104 (e.g., in the second configuration) when the ground speed of the mobile machine 100 is decreased from the ground speed at which the mobile machine 100 is currently moving. In some embodiments, the controller 190 is configured to compare the ground speed of the mobile machine 100 with a predefined threshold. If the ground speed is greater than the predefined threshold, the controller 190 is configured to control the actuator 174 to tilt the perception device 130 upward with respect to the ground speed. Similarly, if the ground speed is less than the predefined threshold, the controller 190 is configured to control the actuator 174 to tilt the perception device 130 downward with respect to the ground speed.

In some embodiments, the controller 190 may be configured to receive the input which includes a first signal indicative of an initial ground speed of the mobile machine 100 and a second signal indicative of a current ground speed of the mobile machine 100. The controller 190 is further configured to compare the first signal indicative of the initial ground speed with a predefined low-speed threshold and the second signal indicative of the current ground speed with a predefined high-speed threshold. In some embodiments, the predefined low-speed threshold may be equal to the predefined high-speed threshold.

If the initial ground speed is less than the predefined low-speed threshold and the current ground speed is greater than the predefined high-speed threshold, the controller 190 is configured to control the actuator 174 to tilt the perception device 130 upward with respect to the ground plane 104. For example, if the initial ground speed at which the mobile machine 100 was running is increased beyond a certain speed, the controller 190 may control the actuator 174 to tilt the perception device 130 upward with respect to the ground plane 104. In an exemplary embodiment, the ground speed of the mobile machine 100 may be divided into multiple speed ranges.

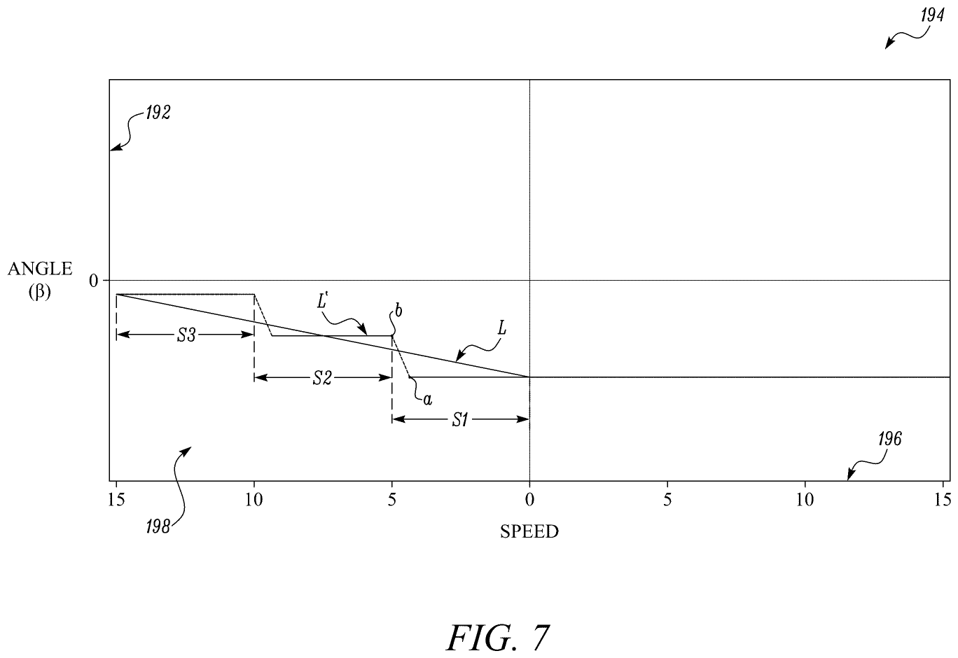

Referring to FIG. 7, exemplary relations between the ground speed (denoted by x-axis 196) of the mobile machine 100 in the rearward direction, R, and the angle β (denoted by y-axis 192) is described by way of curves and/or lines (see a first line, L, and a second line, L′, below) in a graph 194. As exemplarily shown, both the first line, L, and the second line, L′, are represented in a negative quadrant 198 with respect to the ground speed of the mobile machine 100. This is because the ground speed is indicative of the speed of the mobile machine 100 in the rearward direction, R. Similarly, both the first line, L, and the second line, L′, are represented in the negative quadrant 198 with respect to the angle β, of the perception device 130. This is because the perception device 130 is movable downwards with respect to the horizontal axis, A, extending along the length, M, of the mobile machine 100.

The first line, L, on the graph 194 exemplarily indicates that every unit increase in the ground speed of the mobile machine 100, in the rearward direction, R, may correspond to a unit increase in the angle, β, of the perception device 130. The angle β of the perception device 130 may be thus proportional (e.g., directly proportional) to the ground speed of the mobile machine 100 in the rearward direction, R. In other words, when the mobile machine 100 moves in the rearward direction, R, the controller 190 may control the actuator 174 to tilt the perception device 130 upwards based upon the increasing ground speed of the mobile machine 100 in the rearward direction, R. As a result, the angle β may start to increase as the perception device 130 moves from a downward position, e.g., a ‘most downward position’ towards an upward position, e.g., towards a ‘most upward position’.

The ‘most downward position’, as noted above, may be defined as a position of the perception device 130 beyond which the perception device 130 cannot move or pivot further downwards to face the ground plane 104 (e.g., angle β may be minimum). Similarly, the ‘most upward position’, as noted above, may be defined as a position of the perception device 130 beyond which the perception device 130 cannot move or pivot further upwards to face away from the ground plane 104 (e.g., angle β may be maximum). Further, in some embodiments, when the mobile machine 100 moves in the forward direction, T, the angle β of the perception device 130 may remain unaffected by the ground speed of the mobile machine 100 in the forward direction, T, and/or angle β may remain unchanged and/or may remain at a constant angle (for example, at the most downward position throughout a duration for which the mobile machine 100 travels in the forward direction, T). In some embodiments, the angle β may vary from 45 degrees to 90 degrees. For example, the angle β may be 45 degrees at the most downward position and may be 90 degrees at the most upward position. The values noted above are for illustrative purposes only and can include other values.

The second line, L′, on the graph 194 exemplarily indicates that the angle β of the perception device 130 may be altered between multiple discrete angles as the ground speed of the mobile machine 100 in the rearward direction, R, correspondingly shifts between different speed ranges. For example, according to the graph 194, the ground speed of the mobile machine 100 may be analyzed based on three speed ranges (e.g., a first speed range, S1, ranging from 0-5 km/hr (kilometer per hour), a second speed range, S2, ranging from 5-10 km/hr and a third speed range, S3, ranging from 10-15 km/hr). The values noted above are for illustrative purposes only and can include other values.

In such a case, the controller 190 may control the actuator 174 to ensure that angle β remains constantly at a first discrete angle throughout the first speed range, S1; angle β remains constantly at a second discrete angle throughout the second speed range, S2; and angle β remains constantly at a third discrete angle throughout the third speed range, S3. The first discrete angle, the second discrete angle, and the third discrete angle, as iterated in the chronological order, may be exemplarily and correspondingly arranged from the lowest of the discrete angles to the largest of the discrete angles, e.g., with the first discrete angle being the lowest angle and the third discrete angle being the largest angle. In some embodiments, and as shown in FIG. 7, each of the multiple speed ranges may define a predefined low-speed threshold (e.g., point a in FIG. 7) and a predefined high-speed threshold (e.g., point b in FIG. 7).

For example, the low-speed threshold for the first speed range, S1, may be 4 km/hr. Similarly, the high-speed threshold for the first speed range, S1, may be 5 km/hr. Therefore, the controller 190 may control the actuator 174 to tilt the perception device 130 upward when the initial ground speed of the mobile machine 100 is less than 4 km/hr and when the current ground speed of the mobile machine 100 is greater than 5 km/hr.

Similarly, the controller 190 is configured to compare the first signal indicative of the initial ground speed with the predefined high-speed threshold and the second signal indicative of the current ground speed with the predefined low-speed threshold. If the initial ground speed of the mobile machine 100 is greater than the predefined high-speed threshold and the current ground speed of the mobile machine 100 is less than the predefined low-speed threshold. In such a case, the controller 190 is configured to control the actuator 174 to tilt the perception device 130 downward with respect to the ground plane 104. For example, if the initial ground speed at which the mobile machine 100 was running is decreased beyond a certain speed, the controller 190 may tilt the perception device 130 downward with respect to the ground plane 104.

For example, the high-speed threshold for the first speed range, S1, may be 5 km/hr. Similarly, the low-speed threshold for the first speed range, S1, may be 4 km/hr (e.g., when the mobile machine 100 is almost stationary). In such a case, the controller 190 may control the actuator 174 to tilt the perception device 130 downward when the initial ground speed of the mobile machine 100 is more than 5 km/hr and when the current ground speed of the mobile machine 100 is less than 4 km/hr.

When the controller 190 controls the actuator 174 to tilt the perception device 130 with respect to the ground plane 104, the biasing member 186 may exert a reactionary force in a direction opposite to that in which the actuator 174 is exerting a force. This helps in stabilizing the perception device 130 when the mobile machine 100 is running at high speeds by removing any slack or play caused to the perception device 130 by the mobile machine 100 while moving at high speeds, as also described above.

### INDUSTRIAL APPLICABILITY

The operation of the system 170 for operating the perception device 130 will now be discussed with respect to FIGS. 5-6. During operation of the system 170, the controller 190 is configured to receive and compare the input indicative of the ground speed of the mobile machine 100 with the predefined threshold. If the ground speed is zero or approximately zero, the controller 190 is configured to tilt the perception device 130 to a most downward position in the first configuration (please see FIG. 5). In this first configuration, when the mobile machine 100 is stationary, the perception device 130 is configured to detect the object 106 which is very closer to the mobile machine 100 (e.g., immediate surrounding to the mobile machine 100). At this point of time, the vertical field of view, F, of the perception device 130 intersects with the ground plane 104 to detect the object 106 located in a close proximity of the mobile machine 100.

Further, when the mobile machine 100 starts moving in the first direction, R, the controller 190 receive and compare the input indicative of the ground speed of the mobile machine 100 with the predefined threshold. If the ground speed is higher than the predefined threshold, e.g., the mobile machine 100 is moving at a high speed (e.g., 15 km/hr), the controller 190 is configured to tilt the perception device 130 to a most upward position in the second configuration (please see FIG. 6). In this configuration, when the mobile machine 100 is moving at high speed (e.g., 15 km/hr), the perception device 130 is configured to detect the object 106′ which is far away from the mobile machine 100. At this point of time, the vertical field of view, F, of the perception device 130 does not intersect with the ground plane 104 to detect the object 106′ located at a distance from the mobile machine 100.

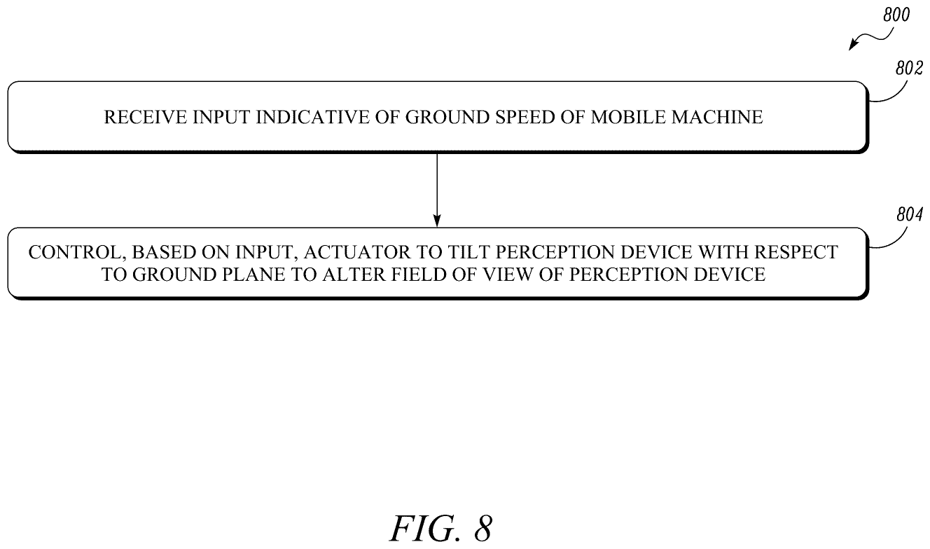

Referring to FIG. 8, an exemplary method of operating a perception device 130 of a mobile machine 100, is discussed. The method is discussed by way of a flowchart 800 that illustrates exemplary stages (e.g., from 802 to 804) associated with the method. The method is also discussed in conjunction with FIGS. 2-6. It will be appreciated that the order of steps described in the method is exemplary in nature and that the steps can be performed in a different order than what is set out below, as will be contemplated by a person skilled in the art based on the description of the present disclosure.

The method begins with receiving the input indicative of the ground speed of the mobile machine 100 by the controller 190 at block 802. The controller 190 may receive the input from the ECM of the mobile machine 100. The input related to the ground speed of the mobile machine 100 may be obtained by one or more speed sensors disposed on the mobile machine 100. The method proceeds to block 804. In some embodiments, the input may include the first signal indicative of the initial ground speed of the mobile machine 100 and the second signal indicative of the current ground speed of the mobile machine 100.

At block 804, the method includes controlling the actuator 174 operably coupled between the perception device 130 and an exterior 112 of the mobile machine 100 by the controller 190. To this end, the controller 190 may output the signal to the actuator 174 to tilt the perception device 130 with respect to a ground plane 104 based on the input indicating the ground speed of the mobile machine 100 received at block 802. As a result, the vertical field of view, F, of the perception device 130 is altered.

In some embodiments, the method may include comparing the initial ground speed with the predefined low-speed threshold and the current ground speed is with the predefined high-speed threshold. Based on the comparison, the method may include actuating the actuator 174 in a manner to tilt the perception device 130 upward with respect to the ground plane 104 if the initial ground speed is less than the predefined low-speed threshold and the current ground speed is greater than the predefined high-speed threshold.

In some embodiments, the method may include comparing the initial ground speed with the predefined high-speed threshold and the current ground speed is with the predefined low-speed threshold. Based on the comparison, the method may include actuating the actuator 174 in a manner to tilt the perception device 130 downward with respect to the ground plane 104 if the initial ground speed is greater than the predefined high-speed threshold and the current ground speed is less than the predefined low-speed threshold.

In some embodiments, when the mobile machine 100 starts moving in a second direction, T, (opposite to the first direction R, see FIG. 1) the controller 190 may detect the direction of the mobile machine 100. As a result, the controller 190 may override or refrain from performing the method as discussed above.

The present disclosure may be configured to automatically tilt the perception device 130 with respect to the ground plane 104 to optimize detection capability when the mobile machine 100 is in the stationary (e.g., stopped) condition and when the mobile machine 100 is moving at high speeds. In this way, the perception device 130 may detect object 106 which are close to the mobile machine 100 in the stationary condition. Further, the perception device 130 may detect object 106′ which are farther from the mobile machine 100 at high speeds without the vertical field of view, F, intersecting the ground plane 104.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

What is claimed is:

1. A system for operating a radar device of a mobile machine, the system comprising:
an actuator operably coupled between the radar device and an exterior of the mobile machine; and
a controller configured to:
receive an input indicative of a ground speed of the mobile machine; and
control, based on the input, the actuator to tilt the radar device with respect to a ground plane to alter a field of view of the radar device.

2. The system of claim 1, wherein the field of view is a vertical field of view spanning between a first field extent and a second field extent to define a vertical viewing angle in a vertical plane extending along a length of the mobile machine.

3. The system of claim 1, wherein the input includes a first signal indicative of an initial ground speed of the mobile machine and a second signal indicative of a current ground speed of the mobile machine, and
wherein, if the initial ground speed is less than a predefined low-speed threshold and the current ground speed is greater than a predefined high-speed threshold, controlling the actuator to tilt the radar device includes tilting the radar device upward with respect to the ground plane.

4. The system of claim 3, wherein, if the initial ground speed is greater than the predefined high-speed threshold and the current ground speed is less than the predefined low-speed threshold, controlling the actuator to tilt the radar device includes tilting the radar device downward with respect to the ground plane.

5. The system of claim 1, further including a spring extending from a mount of the radar device to a body of the radar device, wherein the spring is configured to bias the radar device towards a default tilt corresponding to a stationary state of the mobile machine relative to the ground plane.

6. The system of claim 1, wherein the actuator is an electronic actuator.

7. The system of claim 3, wherein tilting the radar device upward with respect to the ground plane prevents the field of view of the radar device from intersecting the ground plane.

8. A mobile machine, comprising:
an exterior;
a perception device having a field of view; and
a system for operating the perception device of the mobile machine, the system including:
an actuator operably coupled between the perception device and the exterior; and
a controller configured to:
receive an input indicative of a ground speed of the mobile machine; and
control, based on the input, the actuator to tilt the perception device with respect to a ground plane to alter the field of view of the perception device.

9. The mobile machine of claim 8, wherein the field of view is a vertical field of view spanning between a first field extent and a second field extent to define a vertical viewing angle in a vertical plane extending along a length of the mobile machine.

10. The mobile machine of claim 8, wherein the input includes a first signal indicative of an initial ground speed of the mobile machine and a second signal indicative of a current ground speed of the mobile machine, and
wherein, if the initial ground speed is less than a predefined low-speed threshold and the current ground speed is greater than a predefined high-speed threshold, controlling the actuator to tilt the perception device includes tilting the perception device upward with respect to the ground plane to prevent the field of view of the perception device from intersecting the ground plane.

11. The mobile machine of claim 10, wherein if the initial ground speed is greater than the predefined high-speed threshold and the current ground speed is less than the predefined low-speed threshold, controlling the actuator to tilt the perception device includes tilting the perception device downward with respect to the ground plane.

12. The mobile machine of claim 8, wherein the system further includes a spring extending from a mount of the perception device to a body of the perception device, wherein the spring is configured to bias the perception device towards a default tilt corresponding to a stationary state of the mobile machine relative to the ground plane.

13. The mobile machine of claim 8, wherein the actuator is an electronic actuator.

14. The mobile machine of claim 8, wherein the perception device includes a radar device.

15. A method of operating a perception device of a mobile machine, the method comprising;
receiving, by a controller, an input indicative of a ground speed of the mobile machine; and
controlling, by the controller, an actuator operably coupled between the perception device and an exterior of the mobile machine, based on the input, to tilt the perception device with respect to a ground plane to alter a field of view of the perception device.

16. The method of claim 15, wherein the field of view is a vertical field of view spanning between a first field extent and a second field extent to define a vertical viewing angle in a vertical plane extending along a length of the mobile machine.

17. The method of claim 16, wherein the input includes a first signal indicative of an initial ground speed of the mobile machine and a second signal indicative of a current ground speed of the mobile machine, wherein controlling the actuator based on the input includes:
actuating, if the initial ground speed is less than a predefined low-speed threshold and the current ground speed is greater than a predefined high-speed threshold, the actuator in a manner to tilt the perception device upward with respect to the ground plane to prevent the field of view of the perception device from intersecting the ground plane.

18. The method of claim 17, wherein controlling the actuator based on the input includes:
actuating, if the initial ground speed is greater than the predefined high-speed threshold and the current ground speed is less than the predefined low-speed threshold, the actuator in a manner to tilt the perception device downward with respect to the ground plane.

19. The method of claim 15, wherein the actuator is an electronic actuator.

20. The method of claim 15, wherein the perception device includes a radar device.
